(19) United States
(12) Patent Application Publication
(10) Pub. No.: US 2005/0207671 A1
(43) Pub. Date: Sep. 22, 2005

(54) Data presentation device

(76) Inventor: Tadashi Saito, Tokyo (JP)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 10/812,891

(22) Filed: Mar. 31, 2004

(30) Foreign Application Priority Data
Apr. 11, 2003 (JP) 2003-107715

(51) Int. Cl. G06K 9/40

(52) U.S. Cl. 382/275

(57) ABSTRACT

A material presentation device is provided with: a materials stage for placing a material; a camera for capturing the image of the material on the materials stage and supplying a picture signal; an arm for holding the camera in a freely swinging state; a sensor for detecting the angle of rotation of the arm; and an image data processor for selectively correcting the optical distortion of an image that has been captured by the camera based on the amount of displacement of the arm that is obtained from the sensor.

### BACKGROUND OF THE INVENTION

1. Field of the Invention

The present invention relates to a material presentation device that captures an image of materials that are the object of image capture, such as a flat manuscript, a three-dimensional object, or slide film, and that supplies the image to a display device such as a projector or television monitor.

2. Description of the Related Art

A material presentation device is used in a conference or presentation for capturing the image of materials such as a picture, text, three-dimensional object, or slide film, converting to a picture signal, and then, by means of the picture signal, presenting an image of the materials to an audience by means of a display device such as a projector or television monitor.

FIG. 1 shows the state of use of material presentation device 100 of the prior art in which a camera is installed above a materials stage, this figure being a perspective view as seen from the upper right of the material presentation device.

This material presentation device 100 is made up of: materials stage 101 for placing the materials; arm 102 that has one end attached to the outer edge of materials stage 101 such that the arm can swing; camera 103 that is an imaging means, i.e., a means that is equipped with an imaging element and optics as a single unit, this imaging means being rotatably attached to the end of arm 102; and light source 104 for illumination that is provided together with and in proximity to camera 103.

The provision of arm 102 that allows swinging and the provision of camera 103 that can be rotated have been disclosed in the prior art, but these provisions in the prior art were principally measures taken merely in consideration of the storage space of material presentation device 100 or simply to allow the optical axis of camera 103 to be turned in any direction for image capture.

The state of use that is shown in FIG. 1 shows the relative positional relation between camera 103 and materials stage 101, whereby materials such as documents are placed on the upper surface of materials stage 101 and an image of the materials is captured by camera 103. In this case, light source 104 is lighted as necessary to illuminate the materials.

Switch 105 is installed on materials stage 101 for use when lighting and extinguishing light source 104 or when selecting functions or making settings for light source 104.

Camera 103 incorporates an imaging device such as a CCD, and the image of the material that is assembled in the imaging device is converted to a picture signal by photoelectric conversion and then supplied as output to a display device (not shown) such as a projector or television monitor that is electrically connected to material presentation device 100. This display device then finally projects a projected image that corresponds to the received picture signal onto, for example, a screen and thus displays an image of the material.

As one type of such a material presentation device, prior art has been disclosed for preventing cases in which picture information of the necessary document cannot be normally obtained due to the direct incidence of the regular reflection component of illumination light that is reflected by a glossy subject to the image capture camera (See paragraphs “0016” and “0017” and FIG. 1 of Japanese Patent Laid-Open Publication No. 2000-125159 (Patent Document 1)).

In addition, prior art has been disclosed for the offset arrangement of the position of the camera away from the operator for the purpose of preventing the camera that is arranged over the materials stage from interfering with the operation of exchanging materials, preventing the camera from blocking the face of the person using the device to give a presentation from the audience, and further, for the correction of the optical distortion (trapezoidal distortion) of the captured image that is caused by image capture from this offset position (See paragraphs “0010,” “0022,” and FIG. 1 of Japanese Patent Laid-Open Publication No. 2002-325200 (Patent Document 2)).

Still further, prior art has been disclosed for arranging the camera so as to allow image capture from a direction that is inclined toward the front of the object of image capture for the purpose of preventing interference from interior lighting encountered with a camera that is arranged over an object that has been placed on the materials stage for image capture, and in addition, supporting the camera so as to allow rotation with respect to the support shaft and then, based on this angle of inclination with respect to the support shaft of the camera, tilting or shifting a lens inside the camera with respect to the optical axis of image capture to correct the distortion of the image of the object (See paragraphs “0013“−”0015” and FIGS. 1, 3, and 4 of Japanese Patent Laid-Open Publication No. 2002-354331 (Patent Document 3)).

However, in the material presentation device that is shown in FIG. 1, the regular reflection component of the illumination light that is reflected by a glossy object is directly incident to the image capture camera, and the object for imaging therefore could not be accurately shown, particularly when light source 104 is turned on.

In addition, there is the problem that when arm 102 is swung or when camera 103 is rotated with respect to arm 102 to capture an image of the material from an angle in order to prevent the direct incidence of the regular reflection component of the illumination light to the image capture camera, the captured image is subjected to the optical distortion that accompanies image capture from an angle.

In patent document 1, the light source and a liquid crystal panel must be arranged on the arm that supports the image capture camera in order to prevent the direct incidence of the regular reflection component of the illumination light that is reflected by a glossy object of image capture to the image capture camera, and these elements not only interfere with the miniaturization and lower cost of the device, but are also unable to block the incidence of the regular reflection component of the lighting of the room in which the device is used.

In patent document 2, the camera pickup angle may be freely altered for the purpose of: preventing the direct incidence of the regular reflection component from external light such as the room lighting, preventing any hindrance to the operation of exchanging materials, and preventing the face of the person using the device to give a presentation from being hidden from the audience. In such cases, a spot light unit, i.e., a light-emitting marker, must be disposed at the four corners of the materials stage for identifying a reference shape to automatically correct the optical distortion of the obtained image that arises according to the image capture angle, and an area that is larger than would otherwise be necessary for presenting materials on the materials stage must be set as the range of images that can be picked up. As a result, when presenting a material, the material must be placed such that it is contained within the range of possible image capture, and the process of smoothly presenting materials is impeded.

Still further, this prior art has the problem that, because the spot light units are installed at the four corners of the materials stage surface, placing a material of a size that covers these spot light units on the materials stage interferes with the normal operation of the function for automatically correcting the optical distortion of a captured image that arises according to the angle of image capture.

When capturing the image of a three-dimensional object that has height and intending to capture an image from an angle other than directly above, the optical distortion of the captured image that arises according to the angle of image capture may not need to be automatically corrected, and in such cases, a switch means was not provided for easily halting the automatic correction function.

In patent document 3, a camera that is not provided with an illuminating light source is merely rotatably supported by the support unit of a supporting column that is secured to the edge of the materials stage, and the movable range of the camera is therefore limited. When the amount of external illumination light is insufficient or when the external illumination light is obstructed by the support column of the camera, a shadow may be cast upon the object of image capture to cause uneven illumination, and the illumination light therefore cannot be effectively irradiated upon the object of image capture. Further, a method in which the lens of the camera itself is shifted or tilted to correct the optical distortion of a captured image requires a complex guide mechanism and drive mechanism, resulting in a costly device. This prior art is further limited in that, in a mode in which the camera is provided as a unit with a notebook computer, a materials stage is not provided; and due to the method of detecting the tilt of the optical axis of the camera, the surface of the material and the surface of the main body of the personal computer must be in the same plane.

It is therefore an object of the present invention to provide a material presentation device that can not only prevent the face of a person using the material presentation device to give a presentation from being hidden from the audience, but that can also, in a case in which the angle of image capture of the camera is made freely variable to prevent light from the illumination light source or external light from the area of use from being reflected by the object of image capture into the camera and thus preventing normal image capture, to successively detect this angle of image capture and then automatically correct the optical distortion of the captured image according to the angle of image capture.

### SUMMARY OF THE INVENTION

It is yet another object of the present invention to provide a material presentation device in which a function for automatically correcting the optical distortion of the captured image in accordance with the angle of image capture operates normally even when the object of image capture is a picture, document, or three-dimensional object of a size that cannot be accommodated on the materials stage.

Among the objects of the present invention is the provision of a selection means for switching such that the automatic correction function does not operate in cases in which, for example, the camera is intentionally set at an angle other than directly above for capturing the image of a three-dimensional object and no need exists for automatically correcting the optical distortion of a captured image that is produced according to the angle of image capture.

The material presentation device for achieving the above-described objects includes: a materials stage for placing materials that are the object of image capture; an imaging means that is composed of an imaging element and optics as a single unit for picking up the image of materials that are placed on the materials stage and supplying a picture signal as output; a signal output means for supplying a picture signal to the outside; a securing member for holding the imaging means in a freely movable state for picking up the image of a material at an angle from a position other than directly above the materials stage; and a means for using a displacement amount detector that detects the amount of displacement of the securing member, and based on the detection results of the displacement amount detector, correcting the distortion of the image that has been captured by the imaging means.

In addition, an image data processor for processing the electrical signal that is obtained from the displacement amount detector and correcting the distortion of the captured image that is produced according to the amount of displacement of the securing member may be provided between the imaging means and the signal output means.

The image data processor may include: a distortion correction processor that is provided with a function for using a distortion correction parameter to correct the optical distortion of a captured image that is produced according to the inclination of the optical axis of the imaging means with respect to the materials stage; a storage unit for storing distortion correction parameters in correspondence with output values of the displacement amount detector; and an arithmetic processor for reading from the storage unit distortion correction parameters that correspond to output values of the displacement amount detector and resetting the distortion correction parameter of the distortion correction processor.

A selection means may also provided for selecting whether or not to execute the distortion correction process for a captured image.

A light source for illuminating a material that is on the materials stage may be provided as a unit adjacent to the imaging means.

A display means may also be provided for displaying an output signal of the signal output means as an image.

In the invention that is configured as described above: the imaging element and optics of the imaging means are configured as a single unit; this imaging means is freely movably held by a securing member so as to allow an image of a material to be captured at an angle from a position other than directly above the materials stage; a displacement amount detector is provided for detecting the amount of displacement of this securing member (for example, the angle); and an image data processor processes an electrical signal that is obtained from this displacement amount detector and corrects the distortion of the captured image that arises in accordance with the amount of displacement of the securing member. More specifically, the image data processor is constituted so as to: calculate the angle of image capture between the imaging means and the material that has been placed on the materials stage based on the output value of the displacement amount detector; based on this calculation result, select a correction parameter of the optical distortion of the captured image that arises during image capture from an angle; and according to the correction parameter, control the distortion correction processor.

By thus allowing free variation of the angle between the materials stage and the securing member for holding the imaging means that picks up an image of the material, the person using the device to give a presentation can freely changing the angle of image capture according to the state of illumination or the state of the object of image capture, and merely by so doing, can successively correct the optical distortion that is produced by imaging the material from an angle. As a result, the user can present a more faithful image of the object of image capture while reducing the regular reflection component of the external lighting that is incident to the imaging element of the imaging means.

In other words, the material presentation device of the present invention: is configured so as to allow arrangement of the imaging means that is used for capturing the image of a material to an appropriate offset position that diverges from a position directly over the central portion of the materials stage by merely swinging the securing member of the imaging means; is provided with an image data processor for correcting the distortion of the image that is captured by the imaging element of the imaging means; and in addition, is capable of detecting the amount of displacement of the securing member by means of a displacement amount detector, and, using a distortion correction processor, successively and automatically correcting the distortion of the image that arises from image capture at an angle based on the output information of the displacement amount detector and thus presenting to the audience an image that appears as if it had been acquired from directly above the materials stage.

The offset position of the imaging means can prevent the direct incidence of the regular reflection of light that is irradiated from the light source into the optics of the imaging means, and for example, even when a glossy document is used as the material, can prevent degradation such as the occurrence of halation in the image that is caused by incidence of regular reflection of light from the light source and thus obtain an accurate image.

In addition, even in the absence of the incidence of regular reflection of light, the offset arrangement of the imaging means can keep the imaging means from blocking or hindering the head or hands of the user and thus facilitate smooth handling such as when the presenter, i.e., the user of the device, exchanges materials on the materials stage or points out and explains the materials, and further, can prevent the face of the presenter from being hidden from the audience.

Still further, the light source for illuminating materials is provided as a single unit in proximity with the imaging means, and the optical axis of the light is therefore identical to the optical axis of image capture of the imaging means, and when a three-dimensional object is used as a material and is imaged from an angle and presented to the audience, the object for image capture can therefore be effectively illuminated. In addition, swinging the arm enables positioning the camera at an image capture position directly over the materials stage, whereby the image of a three-dimensional object can also be acquired from directly overhead. When presenting the image of the three-dimensional object to an audience and, for example, when intentionally acquiring the image of the three-dimensional object from the side, the automatic correction of the optical distortion of a captured image that occurs when acquiring an image from an angle is no longer necessary. In such a case, a configuration that allows cancellation of the optical distortion correction function by simply manipulating a selection means such as a switch allows materials to be presented smoothly and accurately according to the object of image capture.

Finally, although the distortion correction function in the distortion correction processor of the image data processor can be replaced by shifting or tilting the optics of the imaging means as in the lens of a large-scale camera to reduce or eliminate the optical distortion, such cases necessitate a complex guide mechanism and drive mechanism, and the ability to eliminate distortion through processing by software such as in the present invention is therefore far more economical.

The above and other objects, features, and advantages of the present invention will become apparent from the following description with reference to the accompanying drawings, which illustrate examples of the present invention.

### BRIEF DESCRIPTION OF THE DRAWINGS

FIG. 1 is a perspective view showing the schematic configuration of the material presentation device of the prior art;

FIG. 2A shows the outer appearance as seen from above of a material presentation device in use state according to an embodiment of the present invention;

FIG. 2B shows the outer appearance of the material presentation device according to an embodiment of the present invention, and shows a perspective view of the device when in use;

FIG. 3 is a schematic view showing the state when the direction of image capture of the camera is altered to the direction opposite that shown in FIGS. 2A and 2B;

FIG. 4 is a functional block diagram showing the form of image processing in the material presentation device of an embodiment of the present invention;

FIG. 5 is a schematic view showing the configuration for transmitting the amount of swing of the arm to the displacement sensor in the material presentation device of an embodiment of the present invention; and

FIG. 6 shows an equivalent circuit of the displacement sensor of FIG. 5.

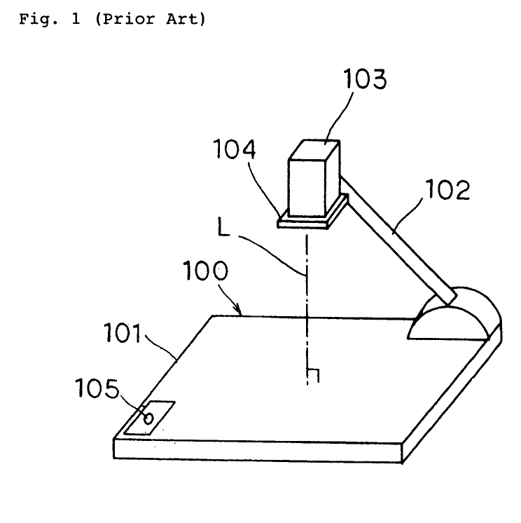

### DETAILED DESCRIPTION OF THE PREFERRED EMBODIMENTS

The following explanation regards embodiments of the present invention with reference to the accompanying figures.

### Embodiment of the Present Invention

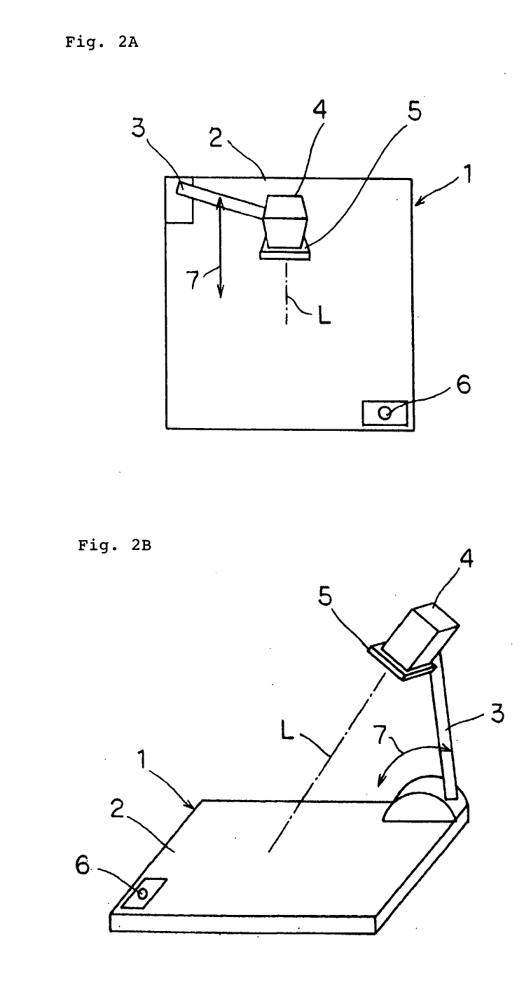

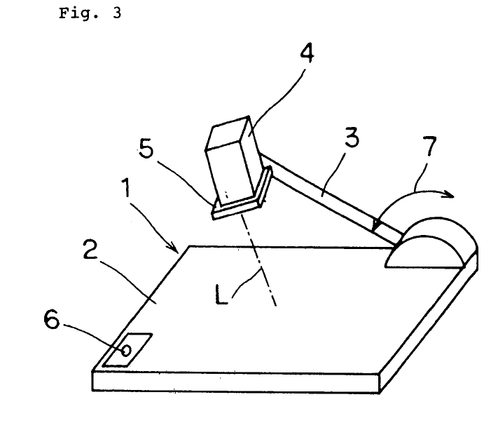

FIG. 2A shows the outer appearance of a material presentation device in use state according to an embodiment of the present invention, this figure showing the state of the material presentation device when in use as seen from above. In addition, FIG. 2B shows the outer appearance of the material presentation device according to an embodiment of the present invention, this figure showing the state of the material presentation device when in use as seen from above and to the right.

FIG. 3 shows the outer appearance of the material presentation device according to an embodiment of the present invention, this figure showing the material presentation device as seen from above and to the right when in a state of use that differs from the states of FIG. 2A and FIG. 2B.

The principal components of the composition of material presentation device 1 of the present embodiment include: materials stage 2 for placing materials such as a picture, document, or three-dimensional object; arm 3 having one end that is attached to the outer edge of materials stage 2 so as to allow a swinging movement; camera 4, i.e., an imaging means in which imaging element and optics are provided as a unit, and that is attached to the other end of arm 3 for acquiring the image of a material that has been provided as an object of image capture; illumination light source 5 that is provided together with camera 4 as a single unit; and switch 6 that is operated for function selection that will be explained hereinbelow. Camera 4 is attached to arm 3 at a fixed angle with respect to arm 3 such that images are acquired from directly above materials stage 2 when arm 3 is at a particular fixed angle with respect to materials stage 2. In addition, a switch distinct from switch 6 is also provided (not shown in the figure) for lighting and extinguishing light source 6. Still further, the provision of a light source for emitting light in a plane in an upward direction of the device within materials stage 2 as well as a means for lighting/extinguishing this light source enable a transparent document such as OHP film or slide film to be placed on materials stage 2 for image capture.

Illumination light source 5 is arranged in the vicinity of the lens of camera 4 to enable irradiation of light in the same axial direction as the angle of image capture of camera 4, i.e., the optical axis (axis of image capture) L, and within the range of image capture of camera 4.

Arm 3 is secured so as to allow free swinging in the direction of arrow 7 with the point of connection to materials stage 2 as fulcrum, and this movement allows camera 4, which is the imaging means, to be offset from the central portion above materials stage 2 and positioned at the positions in the states of use shown in FIGS. 2A and 2B and FIG. 3. In FIG. 2B, camera 4 is arranged in the vicinity above the right edge of materials stage 2, while in FIG. 3, camera 4 is arranged in the vicinity above the left edge of materials stage 2, the optical axis L of camera 4 in the states shown in both figures being inclined at angle with respect to the upper surface of materials stage 2. Arm 3 is inclined such that, in particular, the regular reflection component of the illumination light from light source 5 is not incident to camera 4.

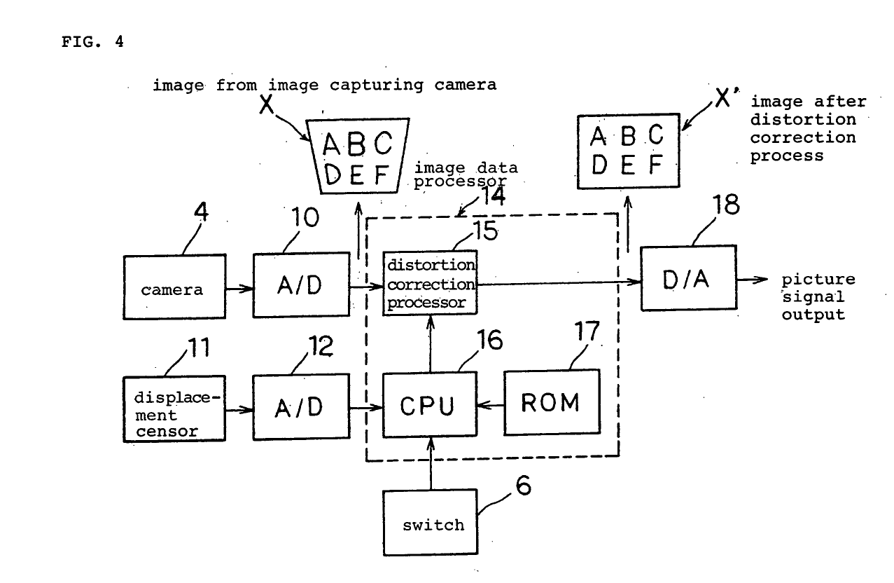

FIG. 4 is a function block diagram showing the internal configuration of material presentation device 1 of the present embodiment.

As shown in this figure, image data processor 14 for correcting distortion of the image captured by camera 4 is included inside the device. This image data processor 14 is provided between A/D conversion circuit 10, which is a circuit for receiving a picture signal from an imaging element (for example, a CCD (charge-coupled device)) that is incorporated in camera 4, and D/A conversion circuit 18, which is a signal output means for supplying the final picture signal to the outside.

The principal components of this image data processor 14 include distortion correction processor 15 that has the function of correcting the optical distortion that is caused by the inclination of optical axis L of the optics of camera 4 with respect to materials stage 2.

Image data processor 14 is further provided with: CPU 16, which is an arithmetic processor; the control software of this device, which operates on CPU 16; and ROM 17, which is a storage means that stores as a data table the various parameters used in the optical distortion correction process. In the present embodiment, RAM that is necessary for the operation of CPU 16 is incorporated in CPU 16.

Displacement sensor 11, which is a displacement amount detector for detecting the angle of inclination (amount of displacement) of arm 3 that holds camera 4, is connected to A/D conversion circuit 12, and the output signal of A/D conversion circuit 12 is connected to the previously described CPU 16.

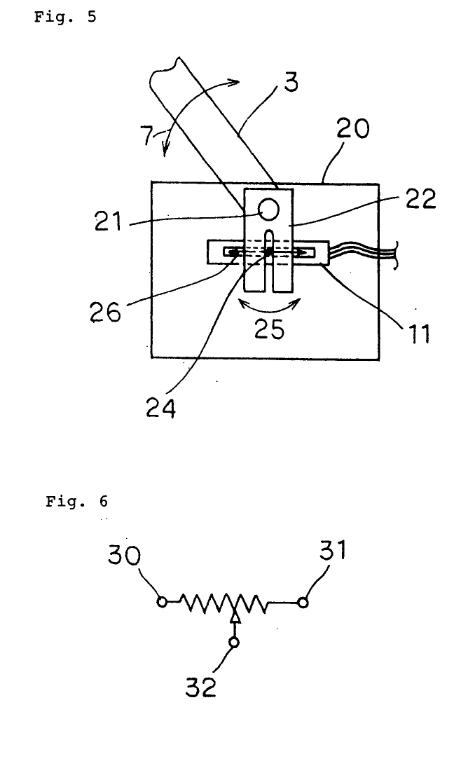

FIG. 5 gives a schematic representation of the construction for converting the change of the angle of arm 3 to linear displacement and conveying this information to displacement sensor 11.

The hinge portion of arm 3 is rotatably attached to hinge support 20 that is established at the corner of materials stage 2. The hinge portion is composed of fulcrum axis 21, which is the fulcrum of the swinging motion of arm 3; and displacement transmission plate 22 for transmitting the rotation of this fulcrum axis 21 to displacement sensor 11 as a linear movement.

Fulcrum axis 21 is secured to the end of arm 3, and moreover, freely rotatably attached to hinge support 20. Displacement transmission plate 22 is also secured to fulcrum axis 21 such that the rotation of this fulcrum axis 21 can move displacement transmission plate 22 in the direction of arrow 25.

A linear groove is formed in displacement transmission plate 22 in the direction away from fulcrum axis 21. Slide knob 24 of displacement sensor 11 fits into this groove, whereby the amount of displacement that is transmitted to displacement sensor 11 is converted to movement in direction 26 in proportion to the amount of the swing motion of arm 3.

FIG. 6 shows an equivalent circuit of the internal circuit of displacement sensor 11. This sensor uses resistance and includes: A terminal 30 on one end of a resistor and B terminal 31 on the other end, and further, S terminal 32 that is connected to a contact that slides on resistor according to the movement of slide knob 24 shown in FIG. 5.

If R (Ω) is the resistance between the two ends of the resistor, i.e., A terminal 30 and B terminal 31; RS (Ω) is the resistance between A terminal 30 and S terminal 32; and a voltage of 0 (V) is applied to A terminal 30 and VS (V) applied to B terminal 31, the voltage VRS (V) that occurs between A terminal 30 and S terminal 32 is VRS=VS·(RS/R).

A/D conversion circuit 12 shown in FIG. 4 is configured to convert the above-described voltage VRS to a digital value and supply this digital value to CPU 16.

In a case in which the angle of attachment of camera 4 to arm 3 is fixed, correlating the amount of swing of arm 3, i.e., the amount of angular change of arm 3 with respect to materials stage 2, to change in the output value of A/D conversion circuit 12 clearly allows the angle of image capture of camera 4 to be easily comprehended or calculated from the output value of A/D conversion circuit 12. Based on the angle of image capture between the object of image capture on materials stage 2 and camera 4, the amount of optical distortion in the obtained image can be found both geometrically and through experimentation.

In this way, CPU 16 establishes correspondence between the output value of A/D conversion circuit 12 and the parameters necessary for the optical distortion correction process that are given to distortion correction processor 15 and stores these parameters as a data table in ROM 17.

Switch 6 is connected to CPU 16 as a selection means by which the operator of this device (the presenter) chooses whether to carry out the optical distortion correction process by detection of the angle of inclination of arm 3.

In addition, the picture signal that has passed through distortion correction processor 15 is converted to an analog signal in D/A conversion circuit 18, and supplied to a display device such as a projector or television monitor.

Explanation next regards the overall processing operations of material presentation device 1 of this embodiment.

A material such as any of a variety of documents is placed on materials stage 2 and is illuminated by the interior lighting and illumination light that is irradiated as necessary from light source 5, and the reflected light is picked up by camera 4. Image formation of the object of image capture is realized in the imaging element by way of optics that are constituted by an image capture lens for image formation in an imaging element such as a CCD. The imaging element of camera 4 subjects this image to photoelectric conversion to supply the image as a picture signal, and A/D conversion circuit 10 converts this picture signal to a digital signal.

The image receiving process that is realized by photoelectric conversion and digital signal conversion is repeatedly executed for each of prescribed cycles, and this picture signal is therefore essentially a moving picture signal.

Obviously, if this image receiving process is executed only once as necessary and a digital signal then saved in, for example, frame memory, this picture signal can be used as a still picture signal.

A picture signal that has been converted to a digital signal is then applied as input to image data processor 14.

However, if the optical axis L of camera 4 is inclined with respect to the picture or document that is placed on materials stage 2 due to the inclination of arm 3 at this time, the image that is obtained from this picture signal will include optical distortion that is produced by the inclination of optical axis L of the optics. If the outline of the material that is placed on materials stage 2 is, for example, a perfect square, the shape of the image will be distorted to the trapezoid indicated by the symbol “X” in FIG. 4.

The side of a material that is positioned on the right side of materials stage 2 in FIG. 2B, i.e., the side of a material that is positioned relatively close to camera 4 corresponds to the long side of trapezoid X in FIG. 4, and the opposite side of the material corresponds to the short side of trapezoid X in FIG. 4.

The picture signal that has been converted to a digital signal is first taken in by distortion correction processor 15 of image data processor 14. On the other hand, the output voltage of displacement sensor 11, in which output voltage changes in proportion to the amount of inclination of arm 3, is applied as input to A/D conversion circuit 12 and converted to a digital value.

This digitized information is taken in by CPU 16 as information of the amount of inclination of arm 3, and CPU 16 searches the data table of ROM 17 based on this information, reads out parameters for optical distortion correction, and supplies the parameters to distortion correction processor 15. Distortion correction processor 15 then uses the parameters for optical distortion correction to execute a process for correcting the optical distortion, i.e., the trapezoidal distortion that is produced by the inclination of optical axis L of the optics of camera 4.

This trapezoidal distortion correction process is already known as a “transformation command” of “perspective” in commercially marketed application programs for image processing. This process is constituted such that the degree of correction can be freely designated by the numerical input of parameters, and explanation of the algorithms of the processing itself is here omitted.

When the inclination of arm 3 is great, the amount of distortion is also great, and a major correction is executed in accordance with the previously described parameters. When the inclination of arm 3 is slight, the amount of distortion is also slight, and a minor correction is executed in accordance with the previously described parameters.

At this time, CPU 16 successively receives the amount of inclination of arm 3, i.e., the output value of A/D conversion circuit 12 for carrying out the appropriate trapezoidal distortion correction process according to the image capture angle of camera 4, searches for the appropriate “distortion correction parameter” from ROM 17 according to the image capture angle at that time, and performs an operation for resetting distortion correction processor 15.

However, as previously described, while successively detecting the amount of inclination of arm 3, CPU 16 also monitors the operation of switch 6, and when the state of switch 6 indicates that the trapezoidal distortion correction process is unnecessary, CPU 16 operates to set a parameter such that distortion correction processor 15 does not perform the trapezoidal distortion correction process.

The image that is distorted to the trapezoidal shape indicated by symbol X in FIG. 4 is restored to the original shape that is indicated by symbol X′ in FIG. 4 by removing or inserting pixel data through interpolation in this trapezoidal distortion correction process.

A picture signal from which distortion, which is trapezoidal distortion produced by the inclination of optical axis L of the optics, has been eliminated in this way is finally converted to an analog signal in D/A conversion circuit 18, supplied to a display device such as a projector or a television monitor, and reproduced as a proper image that is virtually free of distortion.

However, when the display device such as a projector or television monitor is for digital applications, D/A conversion circuit 18 is unnecessary, and the function of the final signal output means is performed by image data processor 14.

### Another Embodiment of the Present Invention

The above-described material presentation device 1 is a form in which the parameters for correcting distortion resulting from the image capture angle of camera 4 are selected by detecting the angle of arm 3 with respect to materials stage 2. However, in a construction that allows rotation of the connection between camera 4 and arm 3, this connection portion may also be provided with a displacement sensor for detecting the image capture angle of camera 4. The image capture angles of camera 4 with respect to materials stage 2 are calculated, and based on each item of angle information, the distortion correction parameters can then be selected. It can thus be easily inferred that the degree of freedom of image capture angle of camera 4 can be increased while still obtaining the desired effect.

The description of the above-described forms was based on a construction in which arm 3 that supports camera 4 can move in only a one-dimensional direction, but it will be obvious that the movable portion of arm 3 can also be constructed to allow two-dimensional movement, and that by arranging each of two angle detection sensors in orthogonal directions, the direction in which camera 4 is inclined with respect to the document placement surface of materials stage 2 can be easily detected. For example, even if the image that is captured from a material having a square outer shape is produced as a rhombus, the combined use of the above-described distortion correction principles will allow the output image following the correction process to be reproduced as a square shape as in the original material.

Still further, in contrast to a configuration in which the displacement sensor that is used in detecting the angle of arm 3 converts the change in the angle of rotation of the arm to a linear direction and transmits this movement to a device that employs principles of sliding resistance, an embodiment can be easily inferred having a configuration in which the angle of rotation is detected by transmitting the rotation of the rotational axis of the hinge portion of arm 3 to a rotary encoder that can directly detect rotational displacement, and information for correcting the optical distortion of a captured image then calculated.

While preferred embodiments of the present invention have been described using specific terms, such description is for illustrative purposes only, and it is to be understood that changes and variations may be made without departing from the spirit or scope of the following claims.

1. A material presentation device, comprising:
a materials stage for placing a material that is an object of image capture;
an imaging means composed of an imaging element and optics as a single unit for picking up an image of said material that is placed on said materials stage and supplying a picture signal as output;
a signal output means for supplying said picture signal to an outside;
a securing member for holding said imaging means in a freely movable state for picking up the image of said material at an angle from a position other than directly above said materials stage; and
a means for using a displacement amount detector that detects an amount of displacement of said securing member, and based on detection results of said displacement amount detector, correcting a distortion of the image that has been captured by said imaging means.

2. A material presentation device according to claim 1, further comprising:
an image data processor between said imaging means and said signal output means for processing an electrical signal that is obtained from said displacement amount detector and correcting the distortion of a captured image that is produced according to the amount of displacement of said securing member.

3. A material presentation device according to claim 2, wherein said image data processor comprises:
a distortion correction processor that is provided with a function for using distortion correction parameters to correct optical distortion of a captured image that is produced according to an inclination of an optical axis of said optics of said imaging means with respect to said materials stage;
a storage unit for storing distortion correction parameters in correspondence with output values of said displacement amount detector; and
an arithmetic processor for reading from said storage unit distortion correction parameters that correspond to output values of said displacement amount detector and resetting said distortion correction parameters of said distortion correction processor.

4. A material presentation device according to claim 2, further comprising:
a selection means for selecting whether or not to execute a distortion correction process on a captured image.

5. A material presentation device according to claim 3, further comprising:
a selection means for selecting whether or not to execute a distortion correction process on a captured image.

6. A material presentation device according to claim 1, wherein a light source for illuminating a material on said materials stage is provided as a unit adjacent to said imaging means.

7. A material presentation device according to claim 2, wherein a light source for illuminating a material on said materials stage is provided as a unit adjacent to said imaging means.

8. A material presentation device according to claim 3, wherein a light source for illuminating a material on said materials stage is provided as a unit adjacent to said imaging means.

9. A material presentation device according to claim 4, wherein a light source for illuminating a material on said materials stage is provided as a unit adjacent to said imaging means.

10. A material presentation device according to claim 5, wherein a light source for illuminating a material on said materials stage is provided as a unit adjacent to said imaging means.

11. A material presentation device according to claim 1, further comprising a display means for displaying an output signal of said signal output means as an image.

12. A material presentation device according to claim 2, further comprising a display means for displaying an output signal of said signal output means as an image.

13. A material presentation device according to claim 3, further comprising a display means for displaying an output signal of said signal output means as an image.

14. A material presentation device according to claim 4, further comprising a display means for displaying an output signal of said signal output means as an image.

15. A material presentation device according to claim 5, further comprising a display means for displaying an output signal of said signal output means as an image.

16. A material presentation device according to claim 6, further comprising a display means for displaying an output signal of said signal output means as an image.

17. A material presentation device according to claim 7, further comprising a display means for displaying an output signal of said signal output means as an image.

18. A material presentation device according to claim 8, further comprising a display means for displaying an output signal of said signal output means as an image.

19. A material presentation device according to claim 9, further comprising a display means for displaying an output signal of said signal output means as an image.

20. A material presentation device according to claim 10, further comprising a display means for displaying an output signal of said signal output means as an image.
